(19) United States
(12) Patent Application Publication
(10) Pub. No.: US 2024/0046428 A1
(43) Pub. Date: Feb. 8, 2024

(54) DYNAMIC PIXEL DENSITY RESTORATION AND CLARITY RETRIEVAL FOR SCALED IMAGERY

(71) Applicant: GM GLOBAL TECHNOLOGY OPERATIONS LLC, Detroit, MI (US)

(72) Inventors: Sai Vishnu Aluru, Commerce Twp, MI (US); Sravan Daruri, Walled Lake, MI (US)

(73) Assignee: GM GLOBAL TECHNOLOGY OPERATIONS LLC, Detroit, MI (US)

(21) Appl. No.: 17/817,328

(22) Filed: Aug. 3, 2022

(51) Int. Cl. G06T 5/00; H04N 5/262; G06V 20/58; G06T 3/40

(52) U.S. Cl. CPC G06T 5/003; H04N 5/2628; G06V 20/58; G06T 3/40; G06T 2207/20132; B60W 50/14

(57) ABSTRACT

Systems and methods enhanced image processing with dynamic pixel density restoration and clarity retrieval for scaled imagery including a camera configured to capture an image having a first resolution and a first image clarity, an image processor for receiving the image, scaling the image to a second resolution to generate a scaled image resulting in the scaled image having a second image clarity, the image processor being further operative to adjust a sharpness of the scaled image to generate an adjusted scaled image such that the adjusted scaled image has the first image clarity, a driving assistance processor for generating a motion path in response to the adjusted scaled image, and a vehicle controller for controlling a vehicle in response to the motion path.

### INTRODUCTION

The technical field generally relates to image processing for object detection and presentation in a vehicle, and more particularly relates to a method and apparatus for capturing an image using a vehicle camera, scaling the image and adjusting sharpness of the scaled image for use by an advanced driving assistance system.

The operation of modern vehicles is becoming more automated, i.e. able to provide driving control with less and less driver intervention. Vehicle automation has been categorized into numerical levels ranging from zero, corresponding to no automation with full human control, to five, corresponding to full automation with no human control. Various automated driver-assistance systems, such as cruise control, adaptive cruise control, and parking assistance systems correspond to lower automation levels, while true “driverless” vehicles correspond to higher automation levels. These driver assistance systems must be equipped to determine the environment around them autonomously or semi-autonomously using onboard sensors.

Cameras are often used for optically detecting the environment around the vehicle and can include cameras of different resolutions for different tasks. For example, cameras used to provide a rear view video stream to a user interface can have a higher resolution than a side view camera used for lane marker detection. Current limitations in automotive video architecture force camera usage with higher pixel counts (resolution) to be underused. Achieving higher perception accuracy and object recognition is challenging with higher resolution camera images. Furthermore, using generalized perception algorithms on camera images with different resolutions is equally challenging.

Accordingly, it is desirable to provide improved systems and methods to overcome the previously cited difficulties and provide improved perception accuracy and object detection for images with higher and/or different resolutions. Furthermore, other desirable features and characteristics of the present disclosure will become apparent from the subsequent detailed description and the appended claims, taken in conjunction with the accompanying drawings and the foregoing technical field and background.

### SUMMARY

An apparatus is provided for providing dynamic pixel density restoration and clarity retrieval for scaled imagery. In one embodiment, the apparatus includes a camera configured to capture an image having a first resolution and a first image clarity, an image processor for receiving the image, scaling the image to a second resolution to generate a scaled image resulting in the scaled image having a second image clarity, the image processor being further operative to adjust a sharpness of the scaled image to generate an adjusted scaled image such that the adjusted scaled image has the first image clarity, a driving assistance processor for generating a motion path in response to the adjusted scaled image, and a vehicle controller for controlling a vehicle in response to the motion path.

In accordance with another exemplary embodiment, the apparatus further includes a global positioning system for detecting a vehicle location and a memory for storing a map and wherein the image processor is further operative for cropping the image to a region of interest in response to the map and the vehicle location.

In accordance with another exemplary embodiment, the image processor is operative to downscale the image using an exponential four degree polynomial.

In accordance with another exemplary embodiment, the image processor is operative to upscale the image using a linear four degree polynomial.

In accordance with another exemplary embodiment, an object detection processor for detecting an object within the adjusted scaled image and wherein the image processor is operative to downscale the image to generate the scaled image.

In accordance with another exemplary embodiment, a display for display the adjusted scaled image and wherein the image processor is operative to upscale the image to generate the scaled image.

In accordance with another exemplary embodiment, the image processor is operative to upscale the image to generate the scaled image and wherein the image processor is further operative to sharpen the scaled image to generate the adjusted scaled image.

In accordance with another exemplary embodiment, the image processor is operative to downscale the image to generate the scaled image and wherein the image processor is further operative to blur the scaled image to generate the adjusted scaled image.

In accordance with another exemplary embodiment, the image processor is operative to adjust the sharpness of the scaled image using a wavelet kernel.

In accordance with another exemplary embodiment, a method including capturing, with a camera, an image having a first resolution and a first image clarity, scaling the image, with an image processor, to a second resolution to generate a scaled image resulting in the scaled image having a second image clarity and adjusting a sharpness of the scaled image to generate an adjusted scaled image such that the adjusted scaled image has the first image clarity, generating a motion path, with a driving assistance processor, in response to the adjusted scaled image, and controlling, with a vehicle controller, a vehicle in response to the motion path.

In accordance with another exemplary embodiment, detecting a vehicle location by a global positioning system and cropping the image to a region of interest in response to the vehicle location and a map stored in a memory.

In accordance with another exemplary embodiment, scaling the image includes downscaling the image using an exponential four degree polynomial.

In accordance with another exemplary embodiment, scaling the image includes upscaling the image includes using a linear four degree polynomial.

In accordance with another exemplary embodiment, scaling the image includes downscaling the image to generate the scaled image and detecting an object within the adjusted scaled.

In accordance with another exemplary embodiment, scaling the image includes upscaling the image to generate the scaled image and displaying the adjusted scaled image on a display within a vehicle cabin.

In accordance with another exemplary embodiment, scaling the image includes upscaling the image to generate the scaled image and adjusting the sharpness includes sharpening the scaled image to generate the adjusted scaled image.

In accordance with another exemplary embodiment, scaling the image includes downscaling the image to generate the scaled image and adjusting the sharpness includes blurring the scaled image to generate the adjusted scaled image.

In accordance with another exemplary embodiment, a vehicle including a camera configured to capture an image having a first resolution and a first image clarity, an image processor for scaling the image to generate a scaled image having a second image clarity, the image processor being further operative to adjust the sharpness of the scaled image to generate an adjusted scaled image such that the adjusted scaled image has the first image clarity, and a display for displaying the adjusted scaled image to a vehicle occupant.

In accordance with another exemplary embodiment, the image processor is operative to upscale the image to generate the scaled image and to sharpen the scaled image to generate the adjusted scaled image.

In accordance with another exemplary embodiment, the image processor is operative to crop the image in response to a distortion of the image resulting from a lens of the camera to generate the scaled image.

### BRIEF DESCRIPTION OF THE DRAWINGS

The exemplary embodiments will hereinafter be described in conjunction with the following drawing figures, wherein like numerals denote like elements, and wherein:

FIG. 1 is an exemplary vehicle system including an enhanced image processing system with dynamic pixel density restoration and clarity retrieval for scaled imagery in accordance with various embodiments;

FIG. 2 is a flow chart illustrating an exemplary a method for providing dynamic pixel density restoration and clarity retrieval for scaled imagery in accordance with various embodiments;

FIG. 3 is a graphical representation of image scaling versus image clarity for an image in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

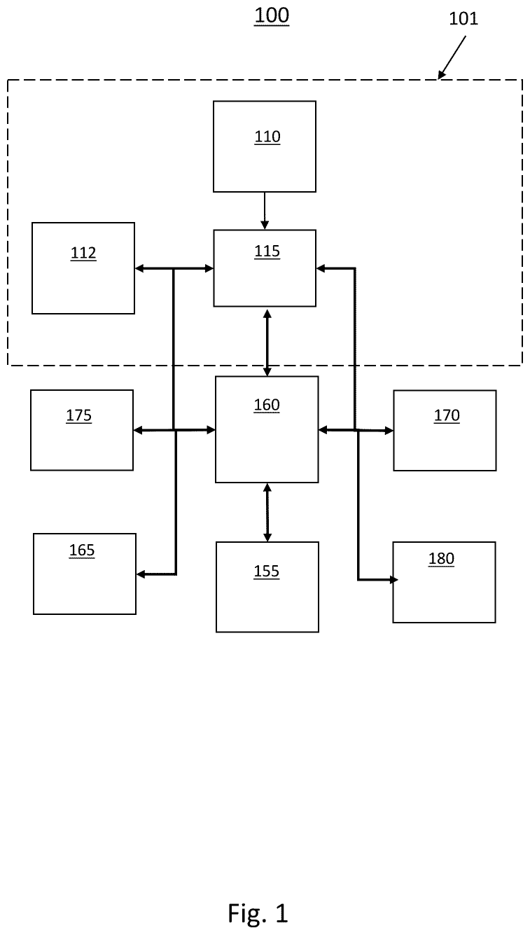

Turning now to FIG. 1, an exemplary vehicle system 100 including an enhanced image processing system 101 with dynamic pixel density restoration and clarity retrieval for scaled imagery is shown in accordance with various embodiments. The exemplary vehicle system 100 includes a first camera 110, a second camera 112, an image processor 115, an ADAS processor 160, a user interface 165, a GPS 175 and a vehicle controller 155. The exemplary image processing system 101 can be configured to utilize one or more cameras depending on design requirements. These cameras can be of the same or differing resolutions. The exemplary image processing system 101 is configured to execute dynamic methods to modify image clarity based on a ratio derived from image scaling for computer vision and perception and for expanding viewing capabilities towards effective utilization of camera resolution. This allows for an integration of cameras with different resolutions into a single processing pipeline for lossless image quality of viewing applications and also increasing object pixel density for computer vision and perception.

The first camera 110 can be mounted on a host vehicle with a forward field of view. The first camera 110 can be mounted to a host vehicle grill, behind a rear view mirror, or on the forward edge of the host vehicle roof. The first camera 110 can be configured to capture an image of the forward field of view and couple this image to the image processor 115. In some exemplary embodiments, the first camera can have a first resolution, such as eight megapixels. In addition, a second camera 112 can be mounted to one or more side view mirror housings with a second field of view that partially overlaps the forward field of view. In some exemplary embodiments, the second camera can have a second resolution different than the first resolution, such as two megapixels. The image from the first camera 110 and an image captured by the second camera 112 can be used for both perception and for display to a driver on a user interface 165, such as a cabin display. In addition, it can be desirable to combine these images to generate an extended view image including the first field of view and the second field of view.

The image processor 115 first scales and/or crops the captured image from either of the first camera 110 or the second camera 112 in response to the desired application. For example, for perception, the image processor 115 can downscale and/or crop the image. For image presentation to a display, the image processor 115 can upscale the image. The image processor 115 then performs a dynamic image clarity modification based on a ratio derived from the image scaling.

In various embodiments, the image processor 115 is configured to perform an exponential polynomial curve fitting for downscaling and a linear polynomial curve fitting for upscaling in response to the relationship between image clarity and image scaling. Correlating image clarity to scaling ratio optimizes the maximization of pixel density and retrieval of relevant data. Normalization of image clarity for both viewing applications and sensing applications, separately, is performed based on respective image scaling ratios. This allows for the image processing system 101 to retain image clarity and retrieve pixel density from scaled images. The exemplary image processing system 101 retains image clarity despite scaling camera resolution in the processing pipeline. The exemplary image processing system 101 can further achieve real-time clarity enhancements by post processing camera images based on upscale or downscale ratios. Object detection and classification can then be performed using the results of the image processing on the scaled image and the resulting data coupled to the ADAS processor 160. The object detection on either the fused image or the image from the first camera 110 can be performed using a trained neural network. The results of the object detection can be used to further train the neural network.

The results of object detection can be then provided as an input to the ADAS processor 160. The ADAS processor 160 can use the detected object information, point cloud, map data stored in a memory 170, location data received in response to a GPS 175 to generate a localized area map relative to the host vehicle. The ADAS processor 160 can further be operative to generate control signals in response to an ADAS algorithm for coupling to the vehicle controller 155 for controlling the host vehicle. For example, the ADAS algorithm can perform an adaptive cruise control operation and generate steering, braking and throttle control information for coupling to the vehicle controller 155. Alternatively, the ADAS processor 160 can generate a motion path in response to the detected object information, map data stored in the memory 170 and host vehicle location data received from the GPS 175 and couple this motion path to the vehicle controller 455.

The user interface 165 can be configured to receive a user input for initiating an ADAS algorithm. In addition, the user interface 165 can be configured to display images and/or the upscaled image from the image processor 115. The user interface 165 can further be configured to provide user alerts, user warnings, and/or ADAS system feedback to a vehicle operator in response to a user alert control signal generated by the ADAS processor 160 and/or the vehicle controller 155.

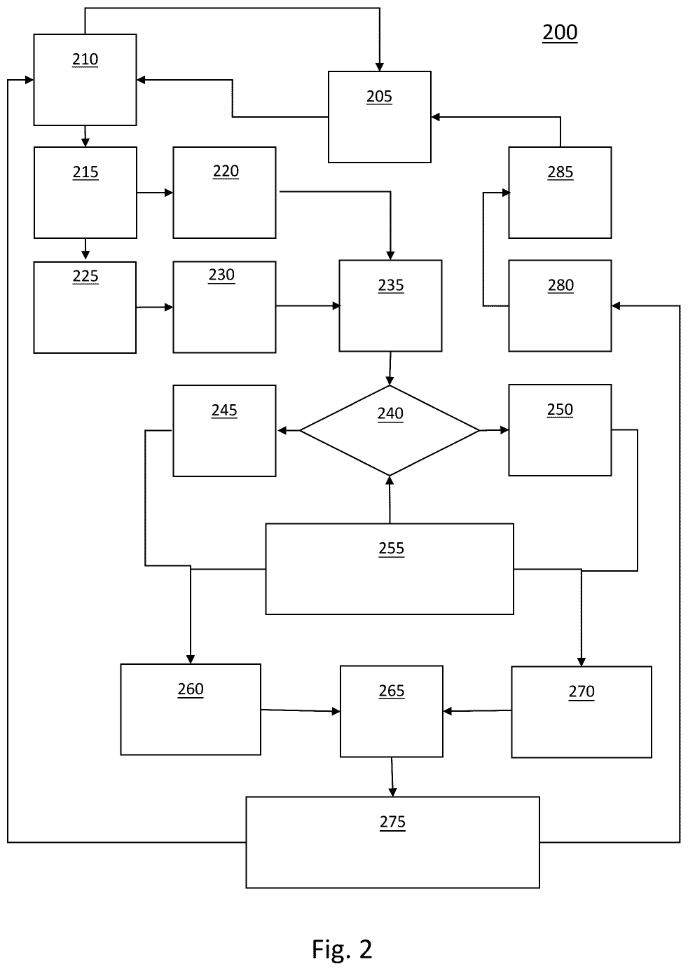

Turning now to FIG. 2, a flow chart illustrating an exemplary implementation of the enhanced image processing system 101 for providing dynamic pixel density restoration and clarity retrieval for scaled imagery is shown. The exemplary method 200 is first operative for performing an advanced driver assistance system (ADAS) algorithm. ADAS algorithms can include adaptive cruise control (ACC), lane keeping ACC, autonomous vehicle control, collision avoidance systems, lane departure warnings, lane change assistance, and the like where real time operating environment awareness is required. The ADAS algorithm can be performed by an ADAS processor, or ADAS controller, within a host vehicle. The ADAS controller can then couple control signals to a vehicle controller for controlling the operation of the host vehicle in response to the ADAS algorithm.

In response to performing an ADAS operation, the exemplary method 200 can next control imaging technology 210 to capture images of the environment surrounding the host vehicle. The imaging technology can include cameras or optical sensors of various resolutions and fields of view. In some exemplary embodiments, the imaging technology can be continuously providing a stream of images, for example a video stream, to a video processor or the like.

The method 200 next acquires a frame 215 of a field of view of interest. For example, the field of view can include a forward field of view from the host vehicle captured by a forward facing camera. The method next determines 220 the original resolution of the acquired image. Frame acquisition can include receiving an image from an image stream from a vehicle camera with a set resolution. For example, the image can be an eight megapixel image received from a forward facing camera. Frames can be requested by other systems, such as ADAS or display and can be used for display to a vehicle occupant or can be used by the ADAS system for object detection or environment perception.

The method 200 is next operative to dynamically scale and/or crop 225 the image. The image can be scaled depending on the application. For example, the image can be upscaled for presentation to a display within the host vehicle. The image can be downscaled to a lower resolution for use by an object recognition algorithm. The image can be cropped to remove areas of the field of view not required by the requesting application. For example, a rear view image can be captured by a fish eye camera, but only an area directly behind the vehicle will be presented to a vehicle occupant during a reversing operation. The method can then crop areas of the image depicting areas outside of the desired area. Likewise, during ACC operations, the image can be cropped to exclude areas outside of the vehicle laneways of interest, thereby reducing image processing computational requirements during image recognition operations. These areas outside of the vehicle laneways of interest can be detected in response to map and GPS data from the host vehicle.

The method is next operative to determine 230 a dynamic scaled resolution of the scaled/cropped image. A scale ratio is next calculated 235 in response to the original image resolution and the scaled image resolution. If the image scale ratio is greater than one 240 indicating an upscaled image, the method is next operative to generate 250 a linear 4D polynomial curve fitting for the scaled image according to a high pass value. If the image scale ratio is less than one 240, the method next generates 245 an exponential 4D polynomial curve fitting for the scaled image according to a lowpass value. In some exemplary embodiments, the high pass and low pass values can be determined from a lookup table in response to the scale ratio and the clarity of the original image.

In the case of an upscaled image, the method is operative to generate 250 a linear 4D polynomial curve fitting for the scaled image. During the upscaling operation, pixels are added throughout the image to fill a gap between pixels of the original image to increase the resolution. The color and luminance of these added pixels are estimated in response to the neighboring pixels of the original image. For example, the pixel luminance can be an average of neighboring pixels from the original image and the color can be a color of the nearest neighboring pixel from the original image. This upscaling can introduce undesirable image artifacts, such as pixelization, clipping, discoloration, ringing and gradient discrepancies.

In response to the scale ratio, image clarity, lowpass values and high pass values are used to generate 265 a wavelet kernel to determine 275 a clarity value for the processed image. This clarity value can then be provided to the imaging technology 210 for use in capturing subsequent images. The scaled image is then processed 280 in response to the generated 4D polynomial curve fitting to generate an image having an image clarity approximately the same as the image clarity of the original captured image.

To address these upscaling artifacts, the scaled image is processed 280 using a linear 4D polynomial curve fitting on the image in order to sharpen the image back to the image clarity of the original image as defined by the modulation transfer function (MTF) of the original image. The linear 4D polynomial curve fitting is a linear function that computes a least squares polynomial for a given set of data. The 4D polynomial curve fitting generates the coefficients of the polynomial, which can be used to model a curve to fit the data. The linear 4D polynomial curve fitting is performed as it is desirable to return the image to the original image clarity to improve image recognition software performance and remove distortions from the upscaled images.

In the case of the downscaled image, an exponential 4D polynomial curve fitting is performed on the scaled image to decrease the image clarity of the downscaled image. The decreased clarity blurs the image to improve image recognition algorithm performance, in part by reducing the occurrence of pixelated lines within the image. The image clarity of the downscaled image is returned to the image clarity value of the original image.

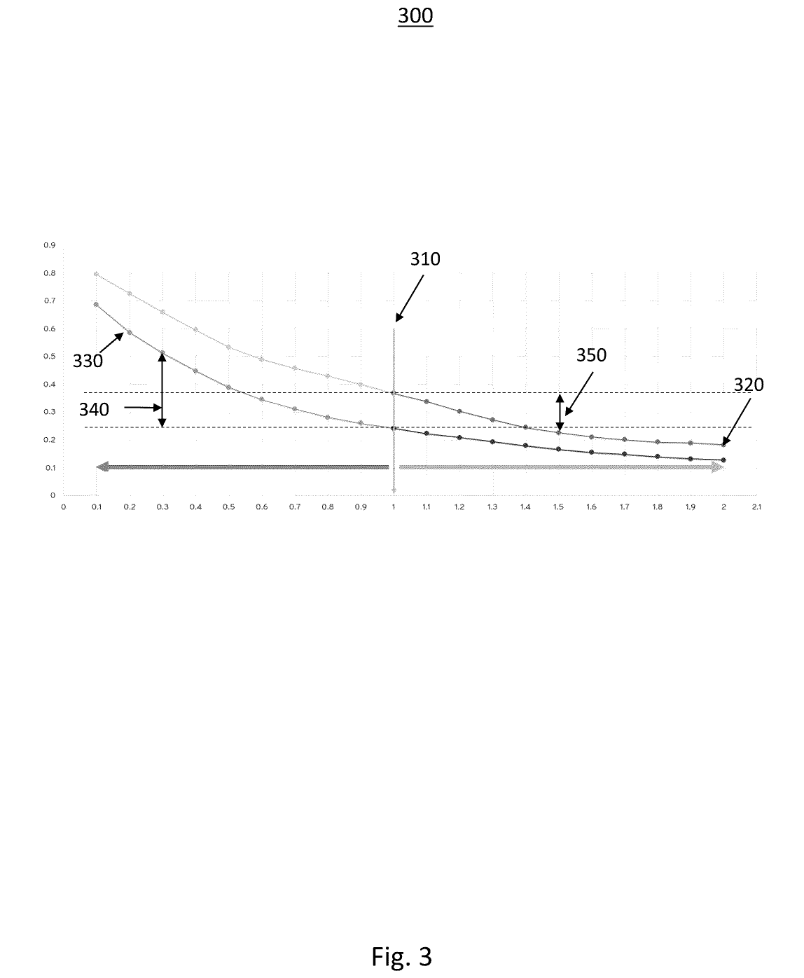

Turning now to FIG. 3, a graphical representation 300 of image scaling versus image clarity for an exemplary image processing operation is shown in accordance with various embodiments. The original camera image resolution 310 is shown in the middle of the graph 300. The graph 300 depicts clarity values vs scaling for a seven megapixel image 330 and an eight megapixel image 320. In these exemplary embodiments, the seven megapixel image has an original image clarity of 0.24 and the eight megapixel image has an original image clarity of 0.38. As the images are linearly upscaled, the image clarity decreases for each of the images. As the images are exponentially downscaled, the image clarity increases for each of the images. It is desirable to now return the image clarity of the scaled images back to that of the original images in order to ensure compatibility of the object detection algorithm for downscaled images and to eliminate visual artifacts and distortions for the upscaled images.

In some exemplary embodiments when the eight megapixel image is linearly upscaled by a factor of 1.5, the image clarity drops from 0.38 to 0.21. The exemplary method is then configured to sharpen 350 the upscaled image to return the upscaled image clarity back to the original 0.38. It is desirable to sharpen the upscaled image to remove distortions and artifacts resulting from the upscaling operation to improve the visual presentation of the image for presentation on a cabin display.

In other exemplary embodiments, when a seven megapixel image is downscaled to 0.3 of the original image resolution, the image clarity increases from 0.24 to 0.51. The exemplary method is then configured to blur 340 the downscaled image to reduce the image clarity of the downscaled image back to 0.24. It is desirable to blur the image to reduce the pixelization of lines and other edges in the image to reduce computational requirements for object detection algorithms and to return the image clarity back to the image clarity of the original image for use by standard object detection algorithms expecting an image of a known image clarity.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An apparatus comprising:
a camera configured to capture an image having a first resolution and a first image clarity;
an image processor configured to receive the image, scale the image to a second resolution to generate a scaled image resulting in the scaled image having a second image clarity, the image processor being further configured to adjust a sharpness of the scaled image to generate an adjusted scaled image such that the adjusted scaled image has the first image clarity;
a driving assistance processor configured to generate a motion path in response to the adjusted scaled image; and
a vehicle controller configured to control a vehicle in response to the motion path.

2. The apparatus of claim 1 further including a global positioning system for detecting a vehicle location and a memory for storing a map and wherein the image processor is further operative for cropping the image to a region of interest in response to the map and the vehicle location.

3. The apparatus of claim 1 wherein the image processor is operative to downscale the image using an exponential four degree polynomial.

4. The apparatus of claim 1 wherein the image processor is operative to upscale the image using a linear four degree polynomial.

5. The apparatus of claim 1 further including an object detection processor for detecting an object within the adjusted scaled image and wherein the image processor is operative to downscale the image to generate the scaled image.

6. The apparatus of claim 1 further including a display for displaying the adjusted scaled image and wherein the image processor is operative to upscale the image to generate the scaled image.

7. The apparatus of claim 1 wherein the image processor is operative to upscale the image to generate the scaled image and wherein the image processor is further operative to sharpen the scaled image to generate the adjusted scaled image.

8. The apparatus of claim 1 wherein the image processor is operative to downscale the image to generate the scaled image and wherein the image processor is further operative to blur the scaled image to generate the adjusted scaled image.

9. The apparatus of claim 1 wherein the image processor is operative to adjust the sharpness of the scaled image using a wavelet kernel.

10. A method comprising:
capturing, with a camera, an image having a first resolution and a first image clarity;
scaling the image, with an image processor, to a second resolution to generate a scaled image resulting in the scaled image having a second image clarity and adjusting a sharpness of the scaled image to generate an adjusted scaled image such that the adjusted scaled image has the first image clarity;
generating a motion path, with a driving assistance processor, in response to the adjusted scaled image; and
controlling, with a vehicle controller, a vehicle in response to the motion path.

11. The method of claim 10 further including detecting a vehicle location by a global positioning system and cropping the image to a region of interest in response to the vehicle location and a map stored in a memory.

12. The method of claim 10 wherein scaling the image includes downscaling the image using an exponential four degree polynomial.

13. The method of claim 10 wherein scaling the image includes upscaling the image using a linear four degree polynomial.

14. The method of claim 10 wherein scaling the image includes downscaling the image to generate the scaled image and detecting an object within the adjusted scaled.

15. The method of claim 10 wherein scaling the image includes upscaling the image to generate the scaled image and displaying the adjusted scaled image on a display within a vehicle cabin.

16. The method of claim 10 wherein scaling the image includes upscaling the image to generate the scaled image and adjusting the sharpness includes sharpening the scaled image to generate the adjusted scaled image.

17. The method of claim 10 wherein scaling the image includes downscaling the image to generate the scaled image and adjusting the sharpness includes blurring the scaled image to generate the adjusted scaled image.

18. A vehicle comprising:
a camera configured to capture an image having a first resolution and a first image clarity;
an image processor for scaling the image to generate a scaled image having a second image clarity, the image processor being further operative to adjust a sharpness of the scaled image to generate an adjusted scaled image such that the adjusted scaled image has the first image clarity; and
a display for displaying the adjusted scaled image to a vehicle occupant.

19. The vehicle of claim 18 wherein the image processor is operative to upscale the image to generate the scaled image and to sharpen the scaled image to generate the adjusted scaled image.

20. The vehicle of claim 18 wherein the image processor is operative to crop the image in response to a distortion of the image resulting from a lens of the camera to generate the scaled image.
